(19) United States
(12) Patent Application Publication
(10) Pub. No.: US 2017/0049071 A1
(43) Pub. Date: Feb. 23, 2017

(54) FLUSHABLE CAT LITTER

(71) Applicant: WILLIAM DALE BROWN, Bainbridge Island, WA (US)

(72) Inventor: WILLIAM DALE BROWN, Bainbridge Island, WA (US)

(21) Appl. No.: 14/828,636

(22) Filed: Aug. 18, 2015

(51) Int. Cl. A01K 1/015; C01D 7/00; A01K 1/01

(52) U.S. Cl. CPC A01K 1/0154; A01K 1/0114; C01D 7/00

(57) ABSTRACT

A flushable cat litter present in a litter box designed to allow a majority of the cat urine to drain into a compartment or container separate from the portion of the litter box holding cat feces and the cat litter. The cat litter preferably includes a mixture of sodium bicarbonate and sodium carbonate.

### BACKGROUND OF THE INVENTION

The present invention generally relates to flushable cat litter.

Prior to the 1950s, cat owners used indoor litter boxes filled with dirt, sand or ashes into which cats were trained to urinate and defecate. In 1947, Edward Lowe invented “Kitty Litter,” composed of a clay mineral named “Fuller's Earth” which is capable of absorbing its weight in water, and thus more absorbent than common dirt, sand or ash. In addition to absorbing urine, Kitty Litter did not get caught in cats' paws nearly as much as dirt, sand or ashes. This is known as “tracking.”

While absorbent clay litter is still in use today, there are more recent types that take into consideration current environmental concerns. The term “biodegradable” is frequently used by cat litter advertisers who are aware of a growing public concern about plastic bags filled with soiled, non-biodegradable litters and the diminishing availability of landfills. Litters termed biodegradable by their manufacturers can be found in the form of granules or pellets, and can be made from a variety of materials, including: corn, wheat, safflower seeds, recycled newspaper, pine, walnut shells, and other materials that will decompose in a landfill within a reasonable length of time.

A sub-category of absorbent litters, known as “clumping litters,” also exists. Clumping litters often contain sodium bentonite clay, and may also contain a clumping additive, such as an adhesive, a cellulosic material and/or a silica gel to enhance clumping. With clumping litters, urine is almost immediately absorbed and forms into a clump on the surface of the cat litter, where it can be easily seen and scooped up instead of draining to the bottom of the litter box.

Each, of the above litters has one thing in common: constituents that absorb urine, known as “desiccants”. Dessicants swell and/or clump upon contact with moisture, and have cat ingestion issues, discussed below.

Odor is one of the major concerns of indoor cat owners, and it is remarkable how such a small animal can emit such a foul smell. We humans have domesticated an animal that in nature does not typically urinate or defecate either at the same time, or in the same place and most often, buries its waste. Humans have trained cats to locate their urine and feces within just a few square inches of a litter box and, in addition, within an indoor environment. Small wonder that we are still searching for a better way to dispose of cat waste. Of the two wastes, feces odor is immediately more powerful but dissipates as it dries. Urine odor, perhaps equally offensive, is much longer-lasting. When the two are contained and mixed in the same box, the mixture can truly be repulsive to both humans and cats alike. Further, when Utter boxes are not kept clean, cats will soon show their dislike by doing their “duties” outside of the box. They will select from any number of inappropriate areas such as hard floors, carpets, beds and other furniture in order to demonstrate that their natural instinct for cleanliness has been violated.

It is worth mentioning that cat litters also enable cats to use their natural instinct to “dig” and “bury” their waste deposits, which is important to most cats. It is possible to train cats to ignore their natural instinct to dig in favor of additional training to induce cats to hop up onto the human toilet to dispose of their waste; however, online comments suggests that this training is difficult and/or relatively unsuccessful.

Selecting the appropriate kind of litter system involves not only the cat but the lifestyle of the owner(s) as well. Flushable cat litter would be ideal due to the ease of its immediate disposal, especially when the box is located next to the toilet, and the fact that the water-filled toilet bowl dilutes the cat waste smell. Compare this to the duties of a cat litter box owner, in which the cat waste (malodorously) lies on the surface of an open box for some time period, and the cat owner must scoop the waste product up with a shovel and then have no choice for disposal other than bagging it.

Internet comments suggest that opinions greatly differ as to what is meant by a “flushable” cat litter—including suggesting that, given the propensity for clogged drain pipes, renters are more likely to flush cat litter than owners! There seems to be growing agreement that clay-based litters should never be flushed. It is also interesting to note that some biodegradable litters that were once advertised as being “flushable”, no longer make that claim. Others have modified their claims to: “Flush in small quantities only.” In this inventor's view there are most likely two reasons for this change in advertising and labeling regarding flushing cat feces and litter down the toilet: (1) too many complaints about clogged drains; and (2) compliance with a California labeling code requiring specific disposal instructions as well as a warning about the pathogen, Toxoplasmosis, on all cat litter containers sold in that state.

Another form of cat litter, known as “crystal litters,” are made from super-absorbent “silica gel” and, like clay, should not be flushed down the toilet. Another drawback to crystal litters is cat ingestion. Cats sometimes will intentionally eat their litter, but most often ingest it while cleaning their paws. While silica gel has been advertised as safe for cats, there have been reports that ingesting a desiccant this powerful is harmful to a cats' intestinal tract as it absorbs moisture too quickly. Many clumping litters contain a combination of both sodium bentonite and silica gel. As each is a desiccant, the combination can be especially harmful to a cats' intestinal tract if swallowed. Another complaint of crystals is that, if they are not cleaned soon enough, they may become saturated beyond their capacity and a pool of urine can form, at the bottom of the litter box.

Another category of cat litter are those which are “biodegradable.” While often friendlier to the ecosystem, these litters have other issues. Cats have been known to ingest some corn and wheat litters, along with other contaminants present in the litter box. In addition, such litters can become infested with molds (e.g., afflatoxin mold) as well as a variety of small insects (meal moths, pantry beetles, etc.).

Tracking is another major complaint about cat litter. Few things are more annoying to cat owners than stepping on a hard pellet in one's bare feet on a hard floor, in the dark, at two o'clock in the morning! Another is observing a litter trail of dusty grains or plastic granules on one's carpeted floor. These annoyances are the result of litter that has been knocked out of the box by the cat digging light-weight seeds or pellets, or from particles that are small enough to cling to the cats' paws, especially when wet. Some cat boxes have “wall extenders” available for an extra charge that, in effect, raises the sides of the box except for the entrance. This helps prevent litter from being kicked out. However, this does not prevent paw tracking. There are a variety of “scratching pads” or other devices available to help minimize paw tracking. The fact that so many extra products like these exist illustrates that high-tracking litters are of concern to many indoor cat owners.

A majority of the “biodegradable” litters are high tracking.

Another category of cat litter is a non-absorbing (non-dessicant) litter, which requires litter boxes that are designed in a completely different manner from those that employ absorbing cat litters. One such litter box that uses non-absorbing cat litter is known as The CatGenie™; this uses plastic granules for litter. During the cleaning cycle, the plastic granules are separated from the feces and urine. The urine and feces are then chemically washed and flushed down the drain. The plastic granules are then dried and reused. Unfortunately, the plastic granules are both high-tracking and non-biodegradable. Further, ingestion of the plastic granules has reportedly caused health problems with cats. In addition, it is reported that even though the litter box machine is designed to flush only feces and urine, the plastic granules sometimes get into the drain system as well. (While The CatGenie™ is mentioned to illustrate that plastic granules have been used for litter, the way in which they are flushed is not really relevant to this invention.)

The following two litter boxes are related to this invention. Each one uses different, but highly non-absorbent litters. They are The Smart Cat™ and The Breeze System®. The Smart Cat™ uses safflower seeds, which are described as biodegradable, dust-free and washable. (Safflower seeds are also reportedly high-tracking, as they are light weight and when wet, adhere to the cat's paws.) The Breeze System® uses small, hard, washable, low-tracking pellets made from a natural, non-toxic mineral, mordenite-zeolite. The purpose of these litter boxes is to separate urine from feces for better sanitation and odor control, and to dispose of them separately as well. In order to accomplish this, these litter boxes require a slotted or perforated bottom. The urine passes through the non-absorbing litter, and then through the perforated bottom; and finally into an underneath storage compartment to be disposed of separately from the feces. With the SmartCat™, urine is deposited into a separate container that should be emptied every few days depending upon the number of cats using it. With The Breeze System®, the storage compartment contains a disposable, deodorized pad that soaks up urine. Urine containment is not reliable once the pads are over-saturated. In short, reported issues with The Breeze System® include: too short a duration of time before the Smart Cat™ urine container needs to be emptied; pad life; and pad cost.

The SmartCat™ and The Breeze System® litter boxes employ litter which is hard-surfaced and does not readily absorb urine. However, this does not mean they can be used indefinitely. While the great majority of the urine reaches the storage compartment, some of the urine will adhere to the litter, and to the surface of the perforated bottom and the storage compartment of the litter box. Eventually, a urine odor level will be reached that will require complete replacement of the litter as well as a thorough cleansing of the cat box. These non-absorbing litters tend to last much longer between changes and/or washing than the traditional absorbing litters. Usefulness for one month or more is not uncommon as opposed to traditional litters that last for only a week or less depending upon the number of cats using the same box. With both of these litters, as well as with the subject of this invention, discussed below, feces should be physically scooped up and disposed of each time, and as soon as possible after the cat defecates for odor and bacterial-growth control.

Another, possibly unforeseen problem with The Breeze System® is that because most cats habitually face in one direction in the litter box when urinating, they urinate in the same place; either the front or back, each time. Thus, half of the urine pad gets over-soaked while the other half is barely used.

Many of the traditional absorbent litters discussed above treat feces odor to varying degrees. Some use natural deodorizers such as pine, while others add artificial deodorants into the litter itself during the manufacturing process. There are also separate deodorizing products available that are either sprinkled on top of the litter or mixed into the litter. Some litter boxes have hoods in order to contain odors, while others separate the feces from the litter by automatically raking the solid waste into a separate compartment for later disposal. Still other litter boxes use manually rotating screens that sift the feces from the litter for disposal instead of hand-scooping it with a shovel. Yet another vents air from the litter box into a tube and out through an open window.

If a litter box is used, the best way to eradicate offensive odor is to dispose of both urine and feces as soon as possible, and to also periodically clean the litter box.

One sub-category of cat litter odor, the initial smell of feces upon defecation, is less offensive with traditional clay and clumping litters than with hard, non absorbent litters. (Cats often do not bury their feces; as a result, it is often left on top of the litter.) The basic reason is that soft and/or small-grained materials, such as clay or wheat, are more easily buried by the cat. The act of clumping also helps cover feces, thereby inhibiting the discharge of fecal gas. In addition, litter boxes that rake fecal waste into separate semi-airtight compartments or have hoods also help to alleviate this problem. Thus, the initial smell of feces upon defecation will inherently be more noticeable with a non-absorbent, hard surfaced litter, and owners will typically wish to scoop and dispose of the feces and then spray the room(s) with a deodorizer.

Traditional, absorbing litters typically provide a more conducive atmosphere for the continued growth of bacteria in the litter box, which is further exacerbated as a result of mixing urine and feces together. The recommended disposal of feces with any litter box, with the exception of some automatic models, is the same for absorbent and non-absorbent litters alike: usually, at least once a day.

In summary, in this inventor's view, separating urine from feces definitely provides a more sanitary environment than when urine and feces are allowed to stand together. This unhealthy environment for cats continues and increases each time additional cat waste is produced. Even when raked into a separate compartment as with some automatic systems, the urine and fecal bacteria continues to grow until such time that it is eventually disposed of by the owner. Yet, with the two exceptions mentioned above (training cats to use a human toilet, and the CatGenie™), all known cat litter boxes store feces and urine for potentially substantial lengths of time (given user changing preferences), which is not sanitary. The goal should be complete disposal as soon as possible; not merely storing for later disposal.

The above-referenced litter boxes with their urine/feces separating systems, as well as others, each use different litters but all of them are non-absorbable litters that remain in their original states for long periods of time, and may be termed “reusable.” They are also often advertised as “washable,” which is true. Needless to say, most cat owners prefer purchasing a new bag rather than washing and drying spent litter.

The litter that is the subject of this invention has the ability to change its state. It remains hard and highly non-absorbent for the desired time of one month or more with one cat. However, at the end of that amount of time, when submerged in water it immediately begins to completely dissolve and disperse, leaving no residue. This process takes less than thirty hours in cold water. This complete dissolution is another characteristic that differentiates the cat litter of the present invention from all other cat litters, as all other cat litters leave some sort of residue “footprint” in the sewer or septic systems.

### SUMMARY OF THE INVENTION

The objects mentioned above, as well as other objects, are solved by the present invention, which overcomes disadvantages of prior animal litter, while providing new advantages not previously associated with animal litter.

In a preferred embodiment, a flushable cat litter is provided in a litter box designed to allow a majority of the cat urine to drain into a compartment or container separate from a portion of the litter box holding cat feces and the cat litter. Preferably, the cat litter comprises a mixture of sodium bicarbonate and sodium carbonate, such as sodium sesquicarbonate, which may be in a pelletized form. If SSC is used, it preferably has a bulk density of less than 80 lb/ft³, and most preferably about 67.5 lb/ft³. SSC in pellet form is low tracking, which is a preferred quality for the cat litter of the present invention. Preferably, too, the cat litter has a water absorption rate of up to about 17% in water at 77° F.

### Definition of Claim Terms

The terms used in the claims of the patent are intended to have their broadest meaning consistent with the requirements of law. Where alternative meanings are possible, the broadest meaning is intended. All words used in the claims are intended to be used in the normal, customary usage of grammar and the English language.

“Flushable” means that the cat litter waste removed from a litter box of conventional size for disposal may be safely flushed down a toilet without clogging a conventional toilet or its attendant piping.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a schematic diagram of a preferred animal litter box to be used with the animal litter of the present invention.

The components in the drawings are not necessarily to scale, emphasis instead being placed upon clearly illustrating the principles of the present invention. In the drawing, like reference numerals designate corresponding parts.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

In a particularly preferred embodiment, the cat litter of the present invention may be a natural mineral, sodium sesquicarbonate (“SSC”), composed of a blend, such as a 50/50 blend, of sodium carbonate and sodium bicarbonate. Its white-to-gray, odorless, needle-shaped crystals are completely water soluble. SSC is non-toxic as it is a common additive in many foods, and is also used as a mild detergent. Due to its properties, cat litter made from 100% pure SSC can not only be safely flushed down the toilet without clogging pipes, as it completely dissolves in water, but it also helps clean the plumbing as well. In addition, if ingested, SSC provides no long term harm as it will dissolve in the warm environment of the cats' intestines.

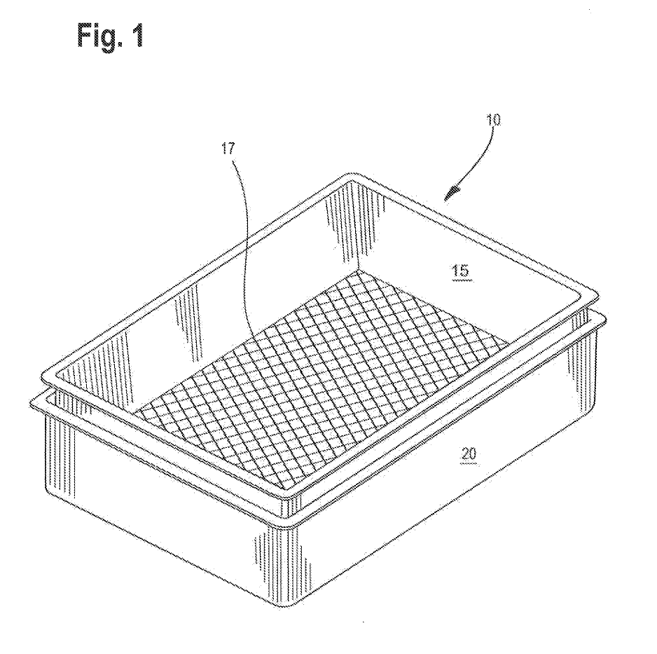

For the sanitary and odor-control reasons discussed above, SSC is only intended to be used as a cat litter with the urine-separating types of litter boxes such as the examples mentioned above (the SmartCat™ and The Breeze System®). Each of them requires a hard-surfaced, non-absorbent litter. Referring to FIG. 1, one preferred embodiment of a cat litter box useful with the present invention is shown. Cat litter box 10 is a stacked, two-part, urine-separating litter box which includes a top litter container 15 with a perforated floor 17, and a bottom urine storage compartment 20. Clumped feces can be removed from perforated floor 17; compartment 20 can be separated from container 15, the urine removed, and then the compartments can be nested again.

Preferably a cat litter should have constituents which are hard enough to repel most of the urine, without absorbing it too quickly. If it dissolves in urine too quickly, it might turn into a high-tracking mush with an intolerable urine odor. Preferably it does not begin to substantially dissolve until the time has arrived for changing the litter box. When that time arrives, it needs to completely dissolve when submerged in water (flushed).

The inventor has found that SSC is preferably not used as cat litter in its natural powdered form, but rather as a solid pellet (e.g., approximately ¼-inch diameter by ½-inch or less, long cylindrical pellets; bulk density of about 67.5lb/ft³). In this form, experimentation determined that when the pellets were submerged in water, without agitation, they dissolved in less than thirty (30) hours. Instead of pellets, the SSC could also be used in tablet form, cubes or other forms.

When using SSC cat litter, it was found that the small number of SSC pellets sticking to the feces when scooped up, could safely be flushed down the toilet periodically without causing any clogging. In fact, given its use as a mild detergent, the SSC pellets are actually believed to aid in cleaning plumbing lines. With the recommended monthly change of spent litter (with one cat), it is preferable that the pellet/feces waste be divided into three or four smaller quantities instead of flushing all at once. Additionally, if desired, hot water could be poured over the pellets before flushing them, as this will accelerate the dissolution. (I found that the pellets dissolved in about 2 minutes in the presence of boiling water, whereas they took as much as 30 hours to dissolve in cold water)

Flushability cannot be claimed by either “Smart Cat™” or “The Breeze System®,” or any other known litter used in urine-separating cat boxes, due to the non-dissolving nature of the cat litters used.

Testing with SSC litter was conducted using a small litter box (14″ long by 10¼″ wide by 3½″ deep), with about 3.4 pounds of SSC pellets (sufficient to provide a litter depth of about one inch); on average, urine was emptied twice/day, and feces once, as a precaution against odor buildup. At the end of two full months, the pellets proved to be low-tracking, and still dry and usable. Even after one month, there was no detectable odor in the room except immediately after a feces deposit. During each one-month period, it was necessary to only replace about 8 ounces of pellets lost during scooping. However, for sanitary reasons, it may still be recommended to completely change the litter each month.

Those of ordinary skill in the art will now appreciate that the slow absorption rate of the pelletized SSC with urine may be affected by several factors, including: (1) the bulk density of the SSC; (2) the size and number of cats using the litter box; and (3) the type of cat litter box used. As to factor (3), as discussed above, preferably, a cat litter box is used which allows urine to separately flow away from the pellets and feces and to be captured in a separate urine container, so that a large majority of the urine is not allowed to remain in contact with the SSC pellets for any substantial amount of time. Using the cat litter box of the type discussed here, SSC pellets of the size mentioned above and with a bulk density of 67.5 lb/ft³, have a moisture absorption rate of up to 17% in 77° F. water.

Again, depending upon the size of the cat box, a technique of dividing the remaining waste contents into three or four flushes would be advisable. As was previously mentioned, water temperature greatly accelerates the SSC dissolving process and, e.g., pouring a kettle of hot water onto the litter, such as in the toilet bowl, may be desirable, to alleviate any fears regarding the litter's ability to dissolve before flushing. It will also be understood that users are not limited to flushing only the small amount of pellets picked up while scooping, but the entire tray of spent litter pellets at the end of the month may be flushed (perhaps in 3-4 separate flushings), as well.

Testing was done to assess the flushability of sodium sesquicarbonate (SSC) when used as a flushable cat litter. Tests 1 through 8, below, show that well over four pounds (over 8 cups) of SSC can be flushed from a common household toilet with no apparent difficulty. The upper limit of flushability was not precisely established but the results of Test 7 indicate that it is between 10 and 12 cups of pellets for a 1.8-gallon flushing toilet.

SSC pellets ¼″ in diameter and approximately ½″ in average length were used for the testing (Batch 5405-1). They were white in color, uniform in shape and not dusty. The original source of the SSC powder (crystals) was The Chemistry Store in Cayce, S.C. The pellets were made from the SSC without the use of any additives. They were used exclusively in all of the tests described herein except Test #7. A previous 3.4 pound batch of SSC pellets was of poorer quality and were of insufficient quantity to test and were used only as a portion of the pellets in Test #7.

The tests were conducted using a standard household toilet (1.6-gallons per flush) mounted on top of a laundry room wash tub. The toilet tank was connected to the wash tub cold water tap. The 2-inch diameter toilet exit was connected to a 2″ PVC elbow, then to a short horizontal length of 2″ PVC pipe, and finally to a 2″ PVC elbow facing downward in order to simulate common household plumbing. The effluent from the last elbow emptied in to a perforated plastic basket lined with a rubber screen having 1/16″ openings so that all pellets and particles larger than 1/16″ diameters were captured for examination and reuse.

The flushability tests were conducted as follows. Varying numbers of 8-ounce cups of pellets were weighed and poured into the toilet bowl all at once and the toilet then flushed. The rate of discharge was noted and the pellets collected on the rubber screen were examined. The results are given in Table 1, below. Since little dissolution could be observed, the pellets from each test were collected and reused in subsequent tests except Test 7, where ail fresh pellets were used (Batch 5401-2). The number of cups and the weights given in Table 1 represent both the amounts of pellets used in the tests as well the calculated weights and cups actually being flushed in each test because of dissolution and slight losses in recovery. The 12% loss per flush that was used in the calculations was based on the fact that after all six tests were completed and the pellets were dried they weighed 4.21 pounds. Thus, during the six tests 2.41 pounds of the 6.62 pounds used were lost primarily due to dissolution and conversion into small particles that passed through the 1/16^{th} inch rubber mesh. This indicates that the dissolution rate of approximately 12% per 10-second flush for SSC pellets in moving cold water is high enough that pellets should pose no clogging problem on their way to sewage treatment. No clumping was observed, i.e., no pellets stuck together. The dried pellets were white with some surface etching and some fines attached to their surfaces.

TABLE 1
Flushability Test Results

| | Total | | Total | | Pounds* | Cups* | |
|---|---|---|---|---|---|---|---|
| | Cups | Cups | Pounds | Pounds | Being | Being | |
| Test | Added | Used | Added | Used | Tested | Tested | Observations |
| 1 | 3 | 3 | 1.64 | 1.64 | 1.64 | 3.00 | Pellets rapidly and |
| | | | | | | | completely flushed out. |
| 2 | 3 | 6 | 1.64 | 3.28 | 3.08 | 5.64 | Same rapid and complete |
| | | | | | | | flushing. |
| 3 | 0 | 6 | 0 | 3.28 | 2.71 | 5.00 | Rerun of Test 2, with |
| | | | | | | | same results. |
| 4 | 2 | 8 | 1.11 | 4.39 | 3.49 | 6.39 | Same rapid and complete |
| | | | | | | | flushing. |
| 5 | 2 | 1.0 | 1.11 | 5.50 | 4.18 | 7.65 | Same rapid and complete |
| | | | | | | | flushing. |
| 6 | 2 | 12 | 1.12 | 6.62 | 4.80 | 8.78 | Same rapid and complete |
| | | | | | | | flushing. |

*Quantities calculated assuming a 12% weight loss by dissolution per flush, which is consistent with the final recovered product weight of 4.21 pounds (4.80 − 12% = 4.22). Since three cups of SSC pellets weighed 1.64 lb, each pound of pellets corresponds to 1.83 cups.

A final test (#7) was done to determine whether or not 12 cups of fresh pellets are flushable. Twelve cups of pellets weigh approximately 6.62 pounds as shown in Table 1. Since only 4.38 pounds of fresh pellets from batch 5405-1 were available, they were combined with 2.24 pounds of pellets from batch 5401-2. The entire 8.82 pounds (12 cups) was poured into the toilet filling it well above the water line, and the toilet flushed. Most, but not all, of the pellets passed through the toilet and plumbing and into the collection basket. There were some pellets visible in the bottom of the toilet. The toilet tank was allowed to refill and the toilet again flushed, causing the rest of the pellets to pass through completely. The pellets collected on the rubber screen weighed 5.94 pounds after drying. The 0.68 pound loss is slightly more than 10% of the starting 6.62 pounds. A major difference between this test and all the other tests was the observation of clumping. It appears that the poorer quality pellets from batch 5401-2 caused the tendency to clump. Thus, in production, pellets should be tested for clumping when wet before use in litter products, even though clumping was not found in either of the other two batches examined in this study. Batch 5401 does appear to be an anomaly. A major observation from. Test #7 is that at least 10 cups of pellets passed through the system on the first flush.

SSC is highly water soluble, up to 17% in water at 77° F., but dissolves slowly when in pellet form due to low surface area. It dissolves into ions which should pose no threat to sewage biochemistry. It is essentially nontoxic (ORAL LD₅₀: >2,000 mg/kg rat) and is used as a food additive. It is essentially a 50/50 mixture of sodium bicarbonate and sodium carbonate.

The above description is not intended to limit the meaning of the words used in the following claims that define the invention. Persons of ordinary skill in the art will understand that a variety of other designs still falling within the scope of the following claims may be envisioned and used. It is contemplated that these additional examples, as well as future modifications in structure, function, or result to that disclosed here, will exist that are not substantial changes to what is claimed here, and that all such insubstantial changes in what is claimed are intended to be covered by the claims.

1. A system including a two-part litter box and a flushable cat litter present in the litter box, wherein the litter box includes a drainable first compartment for receiving cat feces, cat urine and the cat litter, and a compartment which allows a majority of the cat urine to drain from the first compartment into the second compartment, wherein the flushable cat litter is substantially non-absorbent and does not substantially dissolve while present in the first compartment, and then becomes absorbent and substantially dissolves when mixed with water.

2. The system of claim 1, wherein the cat litter comprises sodium sesquicarbonate.

3. The system of claim 1, wherein the flushable cat litter is pelletized.

4. The system of claim 2, wherein the sodium sesquicarbonate has a bulk density of less than 80 lb/ft³.

5. The system of claim 2, wherein the sodium sesquicarbonate has a bulk density of about 67.5 lb/ft³.

6. The system of claim 1, wherein the cat litter is low tracking.

7. The system of claim 1, wherein the flushable cat litter has a water absorption rate of up to about 17% in water at 77° F.

8. The system of claim 1, wherein the first compartment has a perforated floor.

9. A flushable cat litter present which is substantially non-absorbent and does not substantially dissolve while present in a litter box, but which becomes absorbent and substantially dissolves in the presence of water.

10. The flushable cat litter of claim 9, wherein the cat litter comprises a mixture of sodium bicarbonate and sodium carbonate.

11. The flushable cat litter of claim 9, wherein the cat litter comprises sodium sesquicarbonate.

12. The flushable cat litter of claim 9, wherein the cat litter substantially dissolves in the presence of water within 1-2 days.

13. The flushable cat litter of claim 9, wherein the cat litter remains substantially non-absorbent and does not substantially dissolve while present in a litter box, for at least about one month.
